(19) United States
(12) Patent Application Publication
(10) Pub. No.: US 2008/0159715 A1
(43) Pub. Date: Jul. 3, 2008

(54) Contextual linking and out-of-band delivery of related online content

(75) Inventors: Eddie Fuasaro, Sammamish, WA (US); Michael W. Van Flandern, Seattle, WA (US); Daniel L. Poling, Woodinville, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 11/649,112

(22) Filed: Jan. 3, 2007

(51) Int. Cl. H04N 7/26

(52) U.S. Cl. 386/124

(57) ABSTRACT

Content availability online is declaratively or dynamically associated with the presentation of media from a primary media source. The online content is delivered out-of-band with respect to the primary media source for seamless playback alongside the primary content. Traditional media presentation through broadcast television or prerecorded music or video may be extended with new content offerings dynamically delivered using commodity Internet technology either in advance or in real time. Such bonus content may include related video clips and information, cross promotional content, purchase opportunities, extended commercials, and interactive experiences. Particular ancillary content can be personalized per consumer based on their past usage habits.

### BACKGROUND

The promise of a truly interactive television experience has been touted for many years, but has never fully been realized. Most previous attempts to deliver interactive television have relied upon in-band solutions. In one prior implementation, the interactive content itself is delivered in the same transmission stream as the primary content. This method requires significant bandwidth that may only be available with digital cable or satellite transmissions. Further, because of the limitation of bandwidth the range of possible ancillary content offerings are limited. In another prior implementation, identification information as to the location of additional content, generally an Internet address, is transmitted along with the primary media. While not requiring the bandwidth, this method does require special encoding of the source signal and decoding equipment at the user end to extract the location information. Further, there is a delay in retrieving the ancillary or interactive content from across a network, with mixed results across users depending upon network connection speeds. In both prior implementations, special equipment and industry acceptance of transmission standards are required in order to realize the benefits.

### SUMMARY

The technology described herein allows content available online to declaratively or dynamically be associated with the primary media content currently being played back on a consumer's television. The online content may be delivered out-of-band with respect to the primary media content for seamless playback alongside the primary media content. This allows consumers to have a more immersive experience with traditional content by offering and allowing them to consume value-added content and interactive experiences within the context of consuming the primary media content. Traditional media consumption experiences (i.e., broadcast TV, purchased music, DVDs, etc.) may thus be extended with new content offerings that can be dynamically and efficiently delivered using commodity Internet technology. Such bonus content may include related video clips, photographs, music, information, cross-promotional content, purchase opportunities, extended commercials, and interactive experiences. Furthermore, the particular ancillary content offered can be personalized per consumer based on their past usage habits.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all problems or disadvantages noted in any part of this disclosure. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of a home media system implemented about a central media server.

FIG. 2 is a schematic diagram of a media server and a related network for delivering out-of-band media content to a media playback UI.

FIG. 3 is a schematic diagram of a remote server and a related network for packaging out-of-band media content for delivery to a media server.

FIG. 4 is a flow diagram of an implementation of a process on a media server for presenting out-of-band media content to a user.

FIG. 5 is a schematic diagram of a computer system that may operate as a media server or other computer component of a system for presenting out-of-band media content.

### DETAILED DESCRIPTION

The technology described herein concerns the provision of ancillary media content for presentation in conjunction with related primary content for presentation to a consumer of the content. The ancillary media content may originate from a different source than the primary content and may be delivered to a consumer's presentation device via a different transmission system than the primary content. The ancillary media content may be contextually, declaratively, and dynamically associated with the primary media content to augment and enrich the primary media content and ultimately the entire presentation experience. A simple example of primary media content could be, for example, a television show received by the consumer via a cable television subscription. The ancillary media content could be, for example, an offer to purchase a recorded collection of the first season of the television show. In contrast to the cable delivery system for the primary media content, the ancillary media content may be delivered via separate transmissions system, for example, the Internet.

This technology allows consumers to have a more immersive experience with traditional media content by offering to and allowing consumers to consume value-added, ancillary content and interactive experiences within the context of the presentation of the primary content. Traditional media consumption experiences (i.e., broadcast TV, purchased music, DVDs, etc.) may thus be extended with new content offerings that can be dynamically and efficiently delivered using commodity Internet technology. Furthermore, the particular bonus content offered can be personalized for particular consumers based on past usage habits.

Several examples of the types of bonus content that consumers can receive through this technology may include may include the following. Related video clips, photographs, music, and information, e.g., behind-the-scenes footage, previews, character biographies, actor profiles, director commentaries, etc., may be presented as ancillary bonus content to the primary media content. Cross-promotional content, e.g., one-time playback of music tracks featured during the primary media content presentation, previews of upcoming movies/shows from the content publisher, etc., may be presented as ancillary bonus content to the primary media content. Purchase opportunities, for example, the ability to purchase related content such as music, DVDs, soundtracks, movie posters, etc., may be presented as bonus content options to a consumer. Extended commercials, e.g., additional information about the products advertised during the program, which may be interactive or simply extended video advertisements, may be presented as bonus content. Further, interactive experiences, for example, voting opportunities, quizzes, contests, and games relevant to the current context and primary media presentation, may also be presented in addition to the primary media content.

The present technology is unlike other efforts for interactive television that have not gained widespread acceptance due to their reliance on specialized hardware and the requirement for broad industry adoption. The present technology uses commodity Internet technology to provide out-of-band content to customers to create new and compelling media presentations and experiences. The technology also creates value for content publishers, by providing them an audience for peripheral content, cross-promotion, and advertising opportunities resulting in new revenue streams. Further, the technology creates value to the service provider by allowing the service provider to charge a fee or establish a revenue sharing deal with ancillary content publishers in exchange for premium placement.

In-band media is a term used herein to describe media content that is delivered to a presentation device via traditional broadcast or local media delivery systems, for example, over-the-air transmissions, cable, satellite, magnetic media playback, and optical media playback. In-band media may be used interchangeably herein with the term “primary content” to indicate that a media presentation is the principal focus or interest of the consumer of the content. Out-of-band media is a term used here to describe ancillary media content that is delivered separately from the primary media via a separate transmission system or bandwidth. For example, a consumer with a cable television subscription may also have high speed Internet service via the same cable transmission system. However, the television transmissions and the Internet data traffic occur within separate ranges of bandwidth. Thus, the cable Internet transmissions are out-of-band with respect to the television media transmissions. The term “bonus content” is also used herein to refer to the ancillary, out-of-band media content.

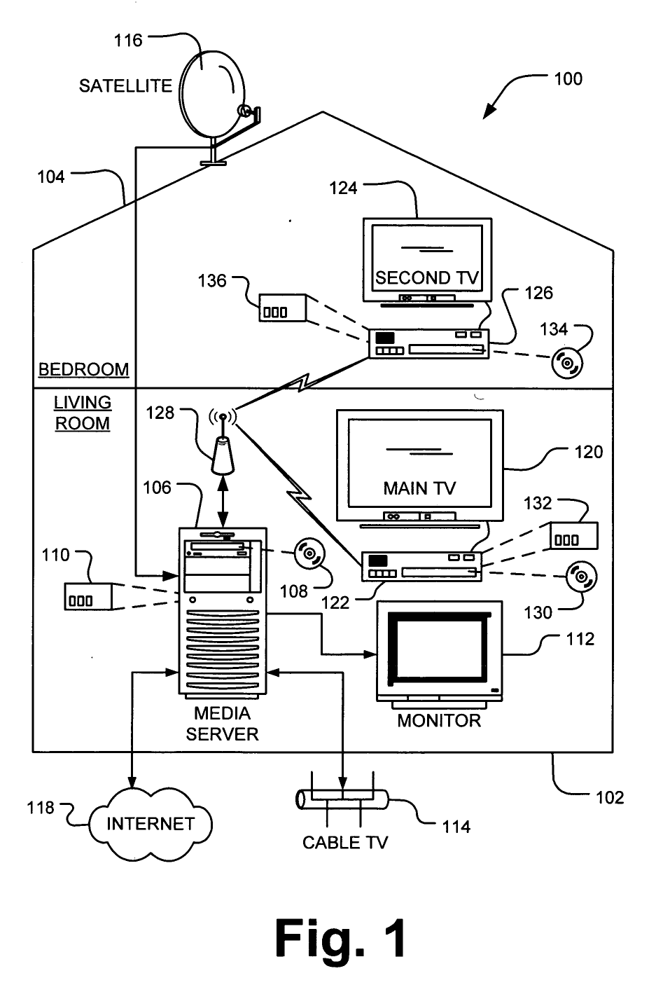

Coordination of in-band media and out-of-band content combined within a UI on a presentation device may be understood in the context of a media server network. FIG. 1 depicts an exemplary home entertainment media network 100 with components positioned throughout a house, e.g., in a living room 102 and a bedroom 104. Central to the media network 100 is a media server 106, in this implementation situated in the living room 102, but it could be located anywhere within the house. In one implementation, the media server 106 may be a conventional personal computer (PC) configured to run a multimedia software package, for example, the Windows® XP Media Center Edition operating system (Microsoft Corporation, Redmond Wash.). In such a configuration, the media server 106 is able to integrate full computing functionality with a home entertainment system within a single PC. For example, a user can watch television (TV) in one graphical window of a video monitor, while sending e-mail or working on a spreadsheet in another graphical window on the same monitor. In the present implementation, the media server 106 may coordinate the presentation of in-band media and related out-of-band content within a UI presented on a presentation device. In addition, the media server 106 may also include other features or components, for example: a personal video recorder (PVR) to capture live TV shows for future viewing or to record the future broadcast of a single program or series; a compact disc (CD) or digital video disc (DVD) drive 108 for disc media playback; a memory drive 110 for integrated storage of and access to a user's recorded content, such as TV shows, songs, pictures, and home videos; and an electronic program guide (EPG).

Instead of a conventional PC, the media server 106 may comprise a variety of other devices capable of storing and distributing media content including, for example, a notebook or portable computer, a tablet PC, a workstation, a mainframe computer, a server, an Internet appliance, or combinations thereof. The media server 106 may also be a set-top box capable of delivering media content to a computer where it may be streamed, or the set-top box itself could stream the media content. As the media server 106 may be a full function computer running an operating system, the user may also have the option to run standard computer programs (e.g., word processing and spreadsheets), send and receive e-mails, browse the Internet, or perform other common functions.

In addition to storing media content, the media server 106 may be connected with a variety of media sources, for example, a cable TV connection 114, a satellite receiver 116, an antenna (not shown for the sake of graphic clarity), and/or a network such as the Internet 118. A user may thus control a live stream of in-band, primary media content (e.g., TV content) received, for example, via the cable connection 114, the satellite receiver 116, or antenna. This capability is enabled by one or more tuners residing in the media server 106. The one or more tuners may alternatively be located remote from the media server 106. In either case, the user may choose a tuner to fit any particular preferences. For example, a user wishing to watch both standard definition (SD) and high definition (HD) content may employ a tuner configured for both types of content. Alternately, the user may employ an SD tuner for SD content and an HD tuner for HD content separately.

The TV content may be received as an analog (i.e., radio frequency) signal or a digital signal (e.g., digital cable). The received TV content may include discrete content packets, where each content packet includes actual TV content (i.e., audio and video data) and a policy or policies associated with the actual TV content. If TV content is received as an analog signal, discrete content packets may be created from the analog signal.

Digital rights management (DRM) policies may be employed to protect the actual TV content or video content digitally stored on the media server 106. Licenses may therefore be associated with the actual TV or video content. A license identifies keys used to decrypt video and TV content (e.g., content packets) that are encrypted as part of DRM. In particular, the keys are used to allow consumption or use of the actual video and TV content. In certain implementations, the content packets of received TV content may be encrypted or compressed. Encrypted content packets are typically decrypted with keys transmitted to or resident at the playback device or home network devices 122, 126.

The media network 100 may also include one or more network devices functioning as media receivers 122, 126 placed in communication with the media server 106 through a network 128, for example, a local area network (LAN). In an exemplary embodiment, the media receivers 122, 126 may be a Media Center Extender device, for example, an Xbox 360™ (Microsoft Corporation, Redmond, Wash.). The media receivers 122, 126 may also be implemented as any of a variety of conventional media rendering or computing devices, including, for example, a digital video recorder (DVR) (a/k/a a personal video recorder (PVR)), a set-top box, a television, a video gaming console, a desktop PC, a notebook or portable computer, a workstation, a mainframe computer, an Internet appliance, a handheld PC, a cellular telephone or other wireless communications device, a personal digital assistant (PDA), or combinations thereof. Each of the media receivers 122, 126 may additionally have optical disc drives 130, 134, respectively, for CD or DVD media playback. Each of the media receivers 122, 126 may also have memory drives 132, 136, respectively, to allow the media receivers 122, 126 to function as a DVR. Furthermore, the media receivers 122, 126 may include a tuner as described above.

The network 128 may comprise a wired and/or wireless network, for example, cable, Ethernet, WiFi, a wireless access point (WAP), or any other electronic coupling means, including the Internet. The network 128 may enable communication between the media server 106, the media receivers 122, 126, and any other connected device through packet-based communication protocols, such as transmission control protocol (TCP), Internet protocol (IP), real-time transport protocol (RTP), and real-time transport control protocol (RTCP). Communications may be transmitted directly between devices over a LAN, or they may be carried over a wide area network (WAN), for example, the Internet 118.

One or more presentation devices, for example a main TV 120 in the living room 102, a secondary TV 124 in the bedroom 104, and a video monitor 112 may be situated throughout the home environment 100. These video display devices may be connected with the media server 106 via the network 128 either directly or via the media receivers 122, 126. As shown in the example of FIG. 1, the main TV 120 and the secondary TV 124 may be coupled to the media receivers 122, 126 through conventional cables. The video monitor 112 may be coupled with the media server 106 directly via a video cable. The media server 106 and media receivers 122, 126 may also or alternatively be coupled with any of a variety of video and audio presentation devices. Media content including TV content may thus be supplied to each of the video display devices 112, 120, 124 over the home network 128 from the media server 106 situated in the living room 104.

The media receivers 122, 126 may be configured to receive streamed primary media content, including video and TV content, from the media server 106. Media content, and particularly video and TV content, may be transmitted from the media server 106 to the media receivers 122, 126 as streaming media comprised of discrete content packets via any of the network protocols described above. The streamed media content may comprise video IP, SD, and HD content, including video, audio, and image files, decoded on the media receivers 122, 126 for presentation on the connected TVs 120, 124. The media content may further be “mixed” with additional content, for example, an EPG, ancillary, out-of-band presentation content related to the primary media content, a web browser window, and other UI environments transmitted from the media server for output on the TVs 120, 124 or the monitor 112. Such additional media content may be delivered in a variety of ways using different protocols, including, for example, standard remote desktop protocol (RDP), graphics device interface (GDI), or hypertext markup language (HTML).

In addition to the media receivers 122, 126 and the video display devices 112, 120, 124, the media server 106 may be connected with other peripheral devices, including components such as digital video recorders (DVR), cable or satellite set-top boxes, speakers, and a printer (not shown for the sake of graphic clarity). The media server 106 may also enable multi-channel output for speakers. This may be accomplished through the use of digital interconnect outputs, such as Sony-Philips Digital Interface Format (S/PDIF) or TOSLINK® enabling the delivery of Dolby Digital, Digital Theater Sound (DTS), or Pulse Code Modulation (PCM) surround decoding.

The technology may be more readily understood in the context of some specific examples of implementations. In a first example, a consumer watches an episode of weekly series on a TV 120. Because the consumer is viewing the TV program through an intelligent media receiver 122 with software configurations for providing ancillary content as described herein, the user is alerted that bonus content is available. Such bonus content may include, e.g., behind-the-scenes footage, character biographies, or sneak previews of the next episode. Each time a consumer views an episode, they may be presented new and fresh content related to the current episode he is viewing. If the episode is recorded and viewed multiple times, the bonus content may be different for the same episode each time it is viewed if new bonus content is available.

In a second example, a consumer may be listening to the latest album by the “Rolling Stones” from their local library of music stored on the media server 106 and output to a media receiver 126, perhaps further connected to an amplifier and speaker system (not shown) in addition to the TV 124 that presents a UI for controlling music selections. Because the consumer is listening to the music through the media receiver 126 with software configurations for providing ancillary content as described herein, the consumer may be alerted that bonus content is available, which may include music videos corresponding to songs on the album, the ability to purchase back catalog albums, or the ability to purchase concert tickets from the artist.

In a third example, a consumer may be watching an episode of a TV program on a TV 120 during which a commercial plays for Ford® trucks. Because the consumer is viewing the commercial through the media receiver 126 with software configurations for providing ancillary content as described herein, the consumer may be alerted that bonus content is available that allows the consumer to play an interactive game and learn more about Ford® trucks. The media receiver 126 may select this particular bonus content from among several options for bonus content available on the media server 106 or media receiver 126 for presentation to this particular consumer. Such a selection may be based upon past behavioral aspects of the consumer stored in memory on the media server 106 or media receiver 126 that indicate this consumer may be interested in purchasing a truck and that he typically selects bonus content offered as an interactive game. A different consumer may be offered an extended video commercial about Fords® trucks based on his previous behavior.

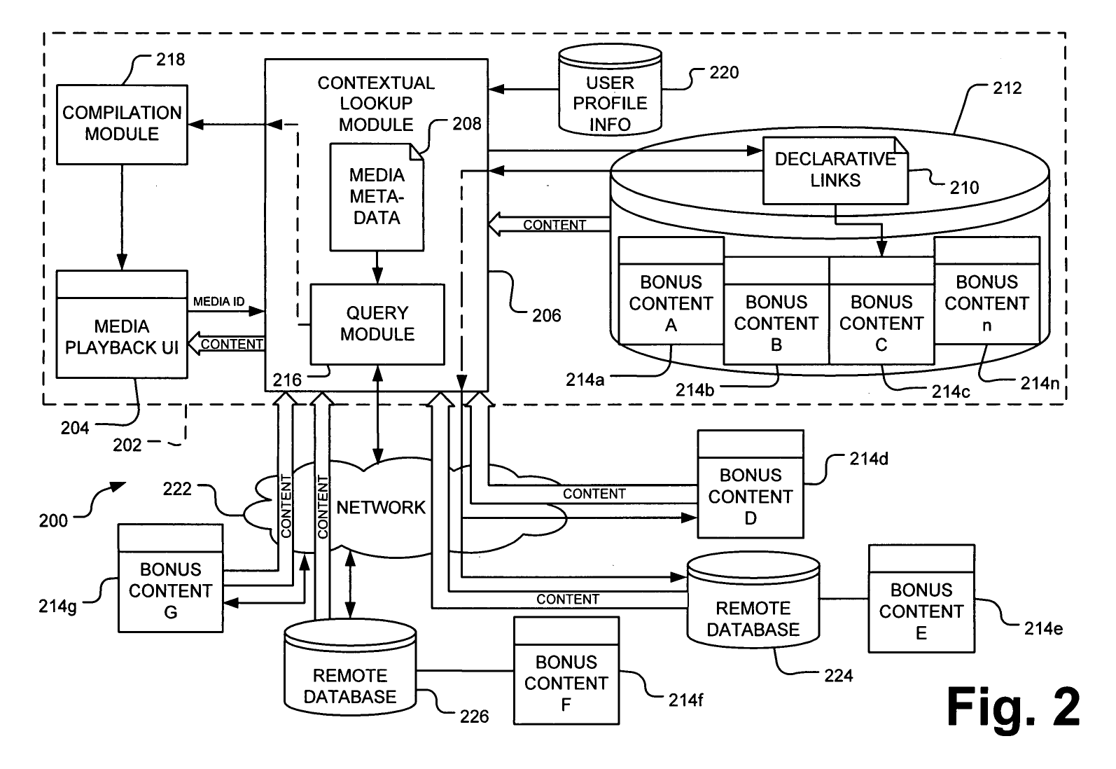

One implementation of a media network 200 anchored by a media server 202 is shown in FIG. 2 and provides an exemplary environment for accessing and presenting out-of-band bonus content to a consumer. When a primary media selection is presented to a consumer via a media playback UI 204 operating on the media server 202, several additional modules may interact with the media playback UI 204 in order to select appropriate bonus content for presentation to the consumer. The media playback UI 204 may pass to a contextual lookup module 206 metadata 208 identifying the primary media being presented. For example, many television programs are assigned a unique identifier called a program ID that appears in header information in digital packet transmissions or in the vertical blanking interval in analog transmissions. Movies saved on storage mediums may also be provided with a unique program ID. Further, individual broadcasting sources may also assign a unique broadcast ID to media programs transmitted over a transmission medium by the broadcasting source.

The program ID, broadcast ID, or other similar program metadata 208, which may be referred to herein simply as identifiers, may be used by various applications to confirm the identity of a particular program. For example, an EPG may watch for the program ID of a television program to confirm that the television program is the selected program and should be recorded per the instructions of the consumer. In the present context, the media metadata 208 may be used to correlate the primary media with ancillary media related to the primary media. In one form, the metadata 208 may be stripped from the primary media by the media playback UI 204 and passed to the contextual lookup module 206 to look-up related bonus content 214a-n. In another form, the metadata 208 may be provided in conjunction with the bonus content 214a-n stored on the media server 202 and may be accessed by or transferred to the contextual lookup module 206 for use in its operations.

In a further configuration, the media server 202 may also track and store user profile information 220 including, for example, information about the usage, preferences, and demographics about the consumer of the primary content. The user profile information 220 may be collected from various sources including, for example, direct input from the consumer, tracking of viewing habits and preferences of the consumer, tracking of selections of previously offered ancillary, out-of-band content, and others. The user profile information 220 may be incorporated into the media metadata 208 by the contextual query module 206 to provide further granularity in selecting the most appropriate bonus content 214a-n.

As indicated above, the bonus content 214a-n may include, for example, related video clips, photographs, music, and information, e.g., behind-the-scenes footage, previews, character biographies, actor profiles, and director commentaries; cross-promotional content, e.g., one-time playback of music tracks featured in the primary media and previews of upcoming movies/shows from the content publisher; purchase opportunities of related content, e.g., music, DVDs, soundtracks, and movie posters; extended commercials providing additional information about the products advertised during the program, which may be interactive or simply extended video advertisements; and interactive experiences, e.g., voting opportunities, quizzes, contests, and games relevant to the current context and primary media presentation. Thus, the bonus content 214a-n may be additional video, photographs, and/or audio content presented by the media playback UI 204 in conjunction with the primary media. Alternately, the bonus content 214a-n may be in the form of an interactive multimedia presentation as a game. Further, the bonus content 214a-n may be in the form of a web page interface providing information and/or allowing the completion of a transaction.

The bonus content 214a-n may be found stored in many locations both on the media server 202 and remote from the media server 202. One location for storage of the bonus content 214a-n may be a data repository 212 on the media server 202. The bonus content 214a-n may be pre-saved in the data repository 212 on the media server 202 by any of several methodologies described in greater detail herein below. Another location for storage of the bonus content 214e may be on a remote data repository 224 accessible by the media server 202 via a network 222. Additional bonus content 214d may be accessible over the network 222 at a discrete location, for example, a particular web page on a web site.

One or more of the bonus content files 214a-n may be applicable to respective primary media presentations. The contextual lookup module 206 may access the bonus content files 214a-n related to a primary media presentation in one or more of several ways. As part of one alternative, a file of declarative links 210 stored on the media server 202 may be accessed by the contextual lookup module 206 to identify an appropriate selection of bonus content 214a-n. The declarative link file 210 may be understood as a file of cross-references between the metadata 208 and the bonus content 214a-n. For example, the declarative link file 210 may be in the form of table of uniform resource indicators (URIs) that point to a respective bonus content file 214a-n for selection ancillary content for contemporaneous presentation with the primary content by the media playback UI 204. Particular metadata 208 may be associated with one or more URIs in the table. The declarative link file 210 may further have notification information for display by the media playback UI 204 to notify the user to the type of bonus content 214a-n available. The declarative link file 210 may be prepared manually or automatically and may be regularly updated to ensure that the bonus content 214a-n is timely, fresh, and appropriate for accompanying the primary content.

The URIs in the declarative link file 210 may be directed to bonus content files 214a-c in the data repository 212 on the media server 202. Upon identification of related bonus content 214a-n within the declarative links file 210, a compilation module 218 may receive the notification information from the contextual look-up module 206. The compilation module 218 may prepare a UI combining the notification information for any related bonus content 214a-n identified and provide a notification UI to the media playback UI 204 for presentation to the consumer listing available ancillary content. Upon selection by a consumer of a particular piece of bonus content 214a-n identified by the declarative links 210, the contextual lookup module 206 may use the URI to access the chosen related bonus content 214c from the data repository 212 on the media server 202. The contextual lookup module 206 may then initiate a playback or presentation of the related bonus content 214c within the media playback UI 204 in conjunction with the primary content.

Alternatively, the URIs in the declarative link file 210 may provide directions to discrete locations accessible via the network 222, for example, a known remote storage location 224 or a particular web page on a web site. The contextual lookup module 206 may use the URIs to directly access the bonus content 214d, 214e over the network 222 and provide the bonus content 214d, 214e to the media playback UI 204 for playback or presentation in conjunction with the primary content.

As an alternative, the contextual lookup module 206 may include a query module 216 in order to perform a search over the network 222 to identify ancillary content not indexed by the declarative links file 210. The query module 216 may use the media metadata 208 to formulate search parameters and seek ancillary content at any available location connected with the network 222. As described above, the metadata 208 may also include user profile information 218, which may also be used by the query module 216 when constructing search parameters to further define types of ancillary, out-of-band content to locate and return for presentation to the consumer. Upon identification of related bonus content 214f, 214g from the network 222, the contextual look-up module 206 may pass any notification information to the compilation module 218 for combination with notification information received from the declarative link file 210. The compilation module 218 may then prepare a UI with combined notification information for any bonus content 214a-n regardless of location and provide the notification UI to the media playback UI 204 for presentation to the consumer.

Upon selection by a consumer of a particular piece of bonus content 214a-n identified by the declarative links 210, the query module 216 may retrieve the bonus content 214f, 214g over the network 222. As when using URIs from the declarative links file 210, the non-indexed, or non-declarative, bonus content 214f, 214g may be located at a remote storage location 226 or a particular web page on a web site. The contextual lookup module 206 may then initiate a playback or presentation of the related bonus content 214c within the media playback UI 204 in conjunction with the primary content.

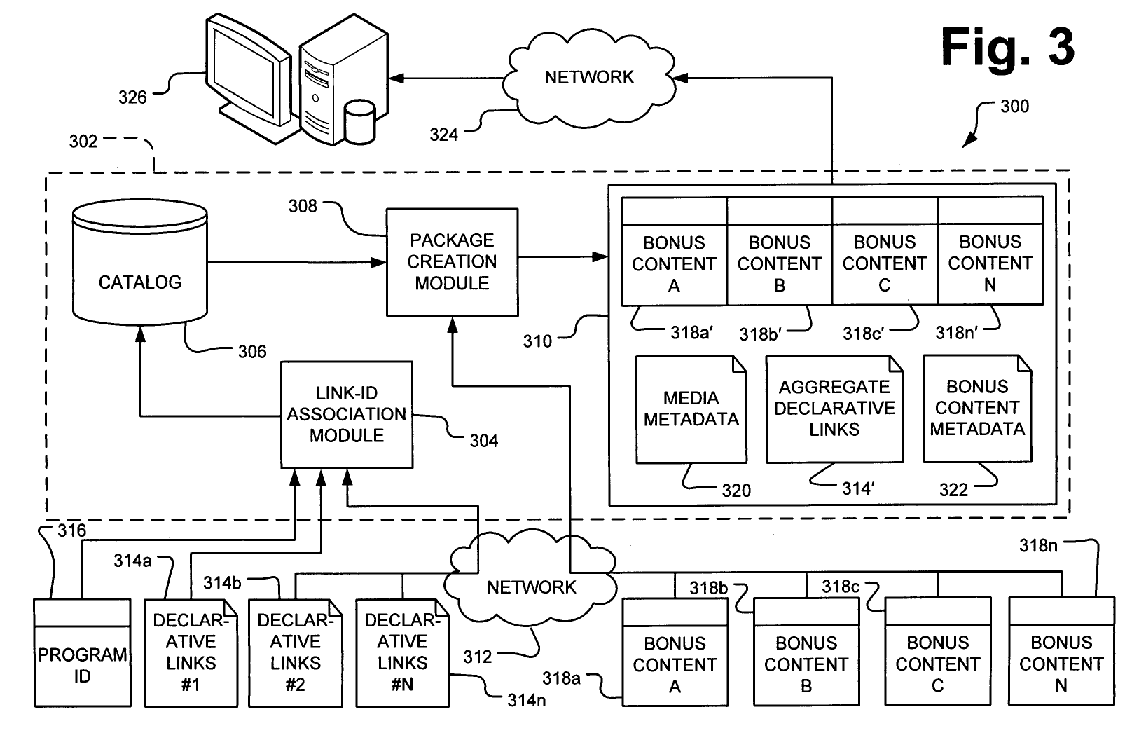

FIG. 3 depicts a system 300 for packaging ancillary bonus content and providing such ancillary content to a consumer's media system 326. The system 300 may include a content server 302 connected to the consumer's system 326 via a network 324, e.g., the Internet. The content server 302 may include several data structures and modules including a link-ID association module 304, a content catalog 306, and a package creation module 308. The link-ID association module 304 accepts input of program ID data 316 and individual declarative link files 314a-n and associates the declarative link files 314a-n with the program ID data 316.

A declarative link file 314a and the program ID data 316 may be input directly to or composed directly within the link-ID association module 304 on the content server 302 by a content manager. Alternatively, declarative link files 314b-n may be authored at a remote location and transmitted to the link-ID association module 304 on the content server 302 via a network 312. (The network transmission of the program ID data 316 is not depicted in FIG. 3 for the sake of graphical clarity.) As indicated in FIG. 3, once an association is made between a declarative link and one or more program IDs 316 in the link-ID association module 304, associated declarative link files may be stored in the catalog 306 on the content server 302 for later use.

The declarative links 314a-n may be authored by broadcasters of the primary content, owners of the primary content, distributors of the primary content, advertisers, or any other party that is a provider of ancillary content that may be appropriately related to the primary content. As noted, the declarative links 314a-n may be authored by an authoring tool, e.g., the link-ID association module 304 hosted by the content server 302 or an authoring tool at some remote location. The declarative links 314a-n may be URIs that indicate a storage and retrieval location for a particular piece of ancillary, out-of-band, bonus content. The URIs or other form of declarative links 314a-n may point to bonus content at any of a variety of locations including, for example, at a remote storage repository, at a web site, or within a package 310 of bonus content stored on the consumer's media server 326 as further described below.

The program ID data 316 may be requested from or sent directly by broadcasters in the case of broadcast media or by content owners or distributors in the case of stored media files, e.g., movies and music stored on DVD, CD, or a hard drive. Generally, the broadcasters or content owners or distributors assign program IDs to any particular piece of primary media content. The program ID data 316 may also include additional metadata that the broadcasters, owners, or distributors want to associate with the primary media.

Bonus content 318a-n for delivery to and storage directly on the media server 326 or other media device of a consumer may be authored and provided by any party interested in providing such content, for example, broadcasters, content owners, content distributors, advertisers, or any other sources. There may be an optional requirement for registration and approval placed upon any potential provider of ancillary content in order to ensure that only bonus content appropriate to the primary content is made available to the consumer. Associated metadata may be authored for inclusion with the bonus content files 318a-n or as a separate file of bonus content metadata 322 to provide additional information regarding the provision of a particular bonus content file 318a-n to a consumer as further described below.

The bonus content 318a-n may be processed on the content server 302 by the package creation module 308 to build a package 310 of bonus content 318a′-n′ and related information for delivery to the consumer's media system 326. The package creation module 308 may access the associated declarative link files in the catalog 306 and create an aggregate file 314′ of declarative links that are to be associated with the bonus content 318a′-n′ in a particular package 310. The package creation module 308 may also provide media metadata 320 related to primary media content. As described above, such primary media metadata 320 may be used by the contextual lookup module on the consumer's media system 326 to optimize the matching between available ancillary content to a particular piece of primary content. The package 310 may additionally contain bonus content metadata 322, which is further described below, that may be used to select a particular one of the bonus content files 318a′-n′ for presentation in conjunction with the primary media content.

Once a package 308 is prepared, it may be transmitted over the network 324 to the consumer's media system 326 for local storage and use in providing bonus content to the consumer. The package 310 may be pushed by the content server 302 to the consumer's media system 326 on a regular schedule or when updated packages are available. It may be appropriate to transmit packages 310 during non-peak usage times, for example, during the middle of the night, so as not to interfere with the consumer's regular use of the network 322 by reducing bandwidth. Alternately, the package 310 may be pulled from the content server 310 upon request from the consumer's media system 326. Packages 310 may be updated regularly to correspond to changes in broadcast schedule of the primary content or to otherwise ensure that the bonus content 318a′-n′ is timely and fresh.

As indicated above, the bonus content 318a′-n′ may include or be packaged with additional information, e.g., bonus content metadata 322 regarding the related bonus content 318a-n′. In one exemplary form, the bonus content 318a-n′ may have an expiration date after which the related bonus content is no longer fresh or appropriate to present in conjunction with the primary media. For example, a contest may be presented as ancillary content with a deadline for entry. Thus, such ancillary content should not be presented to a consumer after the contest entry deadline. In another example, the bonus content could be an advertisement for a sale that is valid until a certain date. The end date of the sale may be provided within the bonus content metadata 322 for use by the contextual lookup module on the consumer's media server to determine whether to present that particular bonus content. Again, the bonus content should not be presented after the period of the sale has ended.

In another exemplary form, the bonus content 318a′-n′ may be localized content, for example, local news, local sports information, or advertisements for businesses local to the consumer. In this respect, the bonus content metadata 322 may include information about local broadcast markets for comparison with broadcast IDs or metadata associated with the primary content. Localized bonus content 318a′-n′ may thus be married to appropriate local programming for a particular market.

In a further exemplary form, the bonus content 318a′-n′ may be targeted to respond to particular, documented consumer behavior. The bonus content metadata 322 may provide consumer demographic or behavior information for correlation with user profile information stored on a consumer's media system 326. As previously described with respect to FIG. 2, the contextual lookup module on the consumer's media server may compare the collected user profile information and compare it with the bonus content metadata 322. The combination of user profile information and the bonus content metadata 322 may thus be leveraged to select the most appropriate bonus content 318a′-n′ for presentation to the consumer.

In one form of implementation, presentation slots for bonus content 318a′-n′ may be sold at different levels or prices, similar to traditional television advertising, based upon the popularity or viewership of the primary content. In another form, presentation slots for bonus content 318a′-n′ may be auctioned off to the highest bidder. Advertisers or other content providers may bid on slots or purchase premium placements for bonus content 318a′-n′ during the process of authoring declarative links 314a-n using the link-ID association module 304.

The modules described above with respect to FIGS. 2 and 3 are exemplary only and are presented as a way of providing simple and practical separation between the various functions performed by the systems. It should be understood that greater or fewer modules may be used to perform the operations described above. For example, one module may be designed to handle the operations of several of the modules described above. Alternatively, multiple functions of one module may be split between several modules.

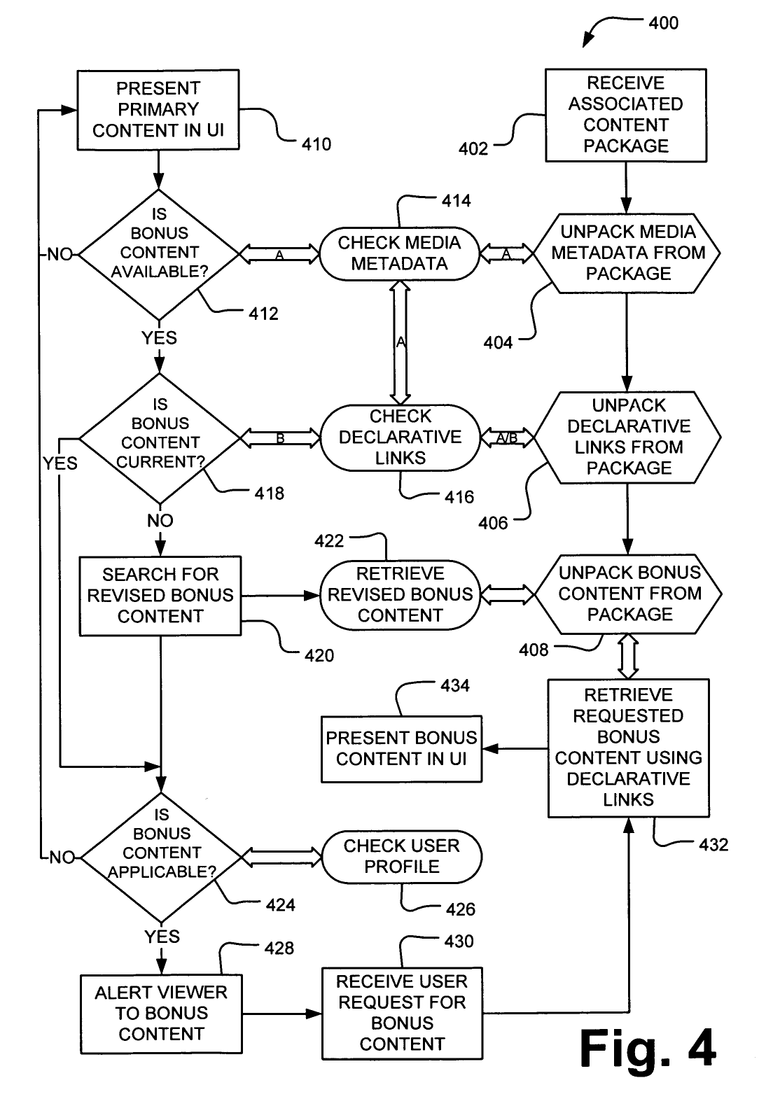

A flow diagram of an exemplary implementation for presenting out-of-band bonus content in conjunction with in-band content on a consumer's media system is depicted in FIG. 4. This implementation may begin at a receiving operation 402 wherein the consumer's media system receives a bonus content package from a content server. Once the package is received, the media metadata related to the bonus content may be unpacked from the package and stored on the consumer's media server or other device in a first unpacking operation 404. Similarly, the declarative links may be unpacked from the package for storage on the consumer's system in a second unpacking operation 406. Likewise, in a third unpacking operation 408, the bonus content may be unpacked from the package and stored in a data repository on the consumer's media system.

Once the packaged bonus content and related information files have been unpacked and stored on the consumer's system, the process is able to offer such bonus content to the consumer contemporaneously with the presentation of the primary, in-band media content. In a presentation operation 410, the primary, in-band content may be presented within a UI configured to simultaneously present related bonus content. In order to present such bonus content, the consumer system must first determine whether any bonus content related to the primary content is available as indicated in a first query operation 412.

Determination of the availability of bonus content in the first query operation 412 may involve several additional steps. First, the media metadata unpacked from the package may be checked in a first checking operation 414 to determine whether the metadata identifies any bonus content related to the present primary program. Regardless of the outcome of this first checking operation 414, a second checking operation 416 may be performed to determine whether any of the declarative links unpacked from the package point to bonus content associated with the primary content. Note that if the media metadata indicated an association of bonus content with the primary content, this association may be used to identify a particular declarative link to find the bonus content conforming to the metadata signature. If no bonus content is available, the UI merely continues to present the primary content as in presenting operation 410.

Even if related bonus content is available, a second query operation 418 may be used to determine whether the bonus content is current. In order to complete this determination, the second checking operation 416 may again be invoked to determine whether a previously identified declarative link is current or whether the content associated with the declarative link is stale or expired. If the bonus content is not current, the system may be instructed to search for revised bonus content that may be available via a network, e.g., the Internet, in a searching operation 420. If revised, alternate, or additional bonus content is found as a result of the search operation 420, the revised bonus content may be retrieved in a retrieving operation 422 for later presentation to the consumer as ancillary content. The retrieved bonus content may be stored on the media system in the same manner as the unpacked bonus content. If in the second query operation 418 it is determined that the bonus content in the package is timely, then the searching operation 420 and retrieving operation 422 may be skipped. Note however, although not indicated in FIG. 4, that the search operation 420 may be performed even if the packaged bonus content is current in order to provide additional content offerings to the consumer.

Once any search for additional out-of-band content had been perform, or not, a third query operation 424 is performed to determine whether the bonus content is applicable to the particular consumer. In order to make this determination, the user profile of the particular consumer stored on the consumer's media system may be consulted in a third checking operation 426. If it is determined that the bonus content is not applicable to the particular user, the procedure may return to the initial presentation operation 410 to present the primary content without any bonus content until related bonus content is identified in the future.

Once it is determined that appropriate bonus content is available, the process may alert the consumer in an alerting operation 428 that bonus content is available. Note that one or more ancillary content files may be available and thus, the consumer may have a choice between more than one piece of bonus content for simultaneous presentation with the primary media content. Once the consumer chooses the desired bonus content, the request is received by the media system in a receiving operation 430. The requested bonus content may then be retrieved in a retrieving step 432 from storage on a device within the media system or from the location at which the search operation 420 located additional content. Once retrieved, the bonus content may be presented in conjunction with the primary, in-band media content within the media playback UI in a presentation operation 434.

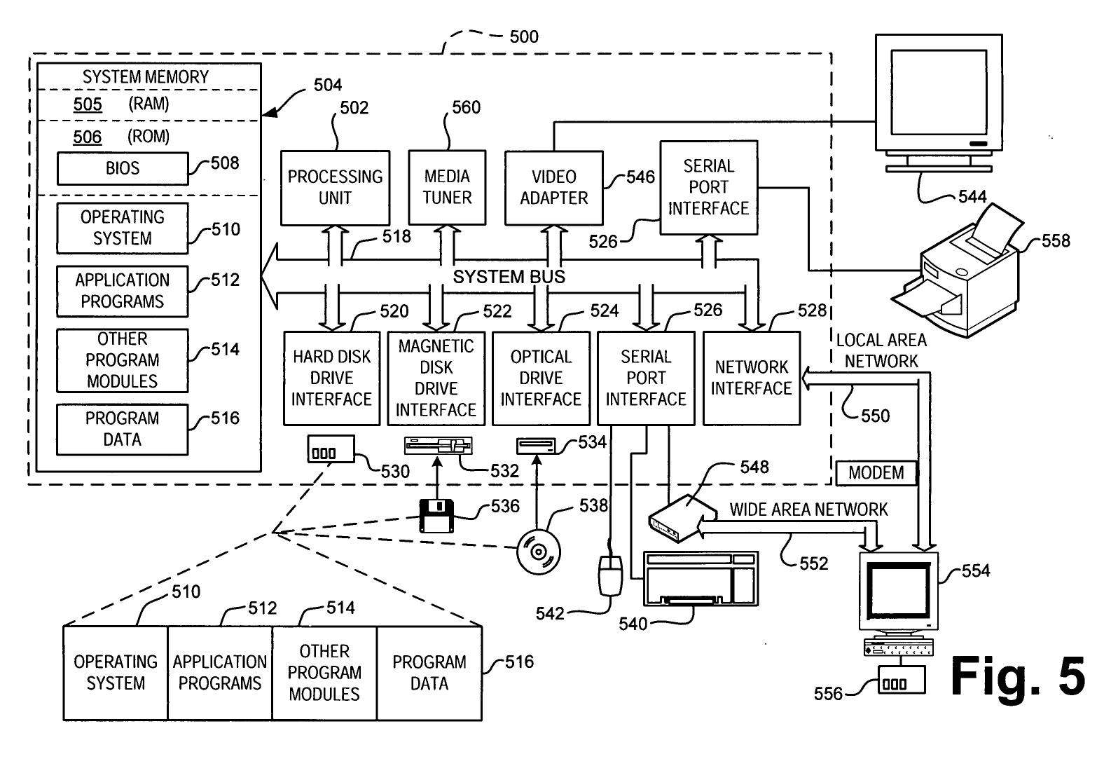

FIG. 5 illustrates an exemplary computer system 500, including hardware and an operating environment, for implementing the invention. For example, each of the media server and media receivers described with respect to FIG. 1 may each be based upon a general purpose computing device in the form of a computer 500, including a processing unit 502, a system memory 504, and a system bus 518 that operatively couples various system components, including the system memory 504 to the processing unit 502. There may be only one or there may be more than one processing unit 502, such that the processor of computer 500 comprises a single central processing unit (CPU), or a plurality of processing units, commonly referred to as a parallel processing environment. The computer 500 may be a conventional computer, a distributed computer, or any other type of computer; the invention is not so limited.

The system bus 518 may be any of several types of bus structures including a memory bus or memory controller, a peripheral bus, a switched fabric, point-to-point connection, and a local bus using any of a variety of bus architectures. The system memory 504 may also be referred to as simply the memory, and includes read only memory (ROM) 506 and random access memory (RAM) 505. A basic input/output system (BIOS) 508, containing the basic routines that help to transfer information between elements within the computer 500, such as during start-up, is stored in ROM 506. The computer 500 further includes a hard disk drive 530 for reading from and writing to a hard disk, not shown, a magnetic disk drive 532 for reading from or writing to a removable magnetic disk 536, and an optical disk drive 534 for reading from or writing to a removable optical disk 538 such as a CD ROM or other optical media.

The hard disk drive 530, magnetic disk drive 532, and optical disk drive 534 are connected to the system bus 518 by a hard disk drive interface 520, a magnetic disk drive interface 522, and an optical disk drive interface 524, respectively. The drives and their associated computer-readable media provide nonvolatile storage of computer-readable instructions, data structures, program modules and other data for the computer 500. It should be appreciated by those skilled in the art that any type of computer-readable media that can store data that is accessible by a computer, for example, magnetic cassettes, flash memory cards, digital video disks, RAMs, and ROMs, may be used in the exemplary operating environment.

A number of program modules may be stored on the hard disk 530, magnetic disk 532, optical disk 534, ROM 506, or RAM 505, including an operating system 510, one or more application programs 512, other program modules 514, and program data 516. In an exemplary implementation wherein the computer system 500 is a media server, the contextual look-up module and query module of FIG. 2, may be incorporated as part of the operating system 510, application programs 512, or other program modules 514. In an additional implementation wherein the computer system 500 is a remote server, the package creation module and link-ID association module of FIG. 3, may similarly be incorporated as part of the operating system 510, application programs 512, or other program modules 514.

A user may enter commands and information into the personal computer 500 through input devices such as a keyboard 540 and pointing device 542, for example, a mouse. Other input devices (not shown) may include, for example, a microphone, a joystick, a game pad, a tablet, a touch screen device, a satellite dish, a scanner, a facsimile machine, and a video camera. These and other input devices are often connected to the processing unit 502 through a serial port interface 526 that is coupled to the system bus 518, but may be connected by other interfaces, such as a parallel port, game port, or a universal serial bus (USB).

A monitor 544 or other type of display device is also connected to the system bus 518 via an interface, such as a video adapter 546. In addition to the monitor 544, computers typically include other peripheral output devices, such as a printer 558 and speakers (not shown). These and other output devices are often connected to the processing unit 502 through the serial port interface 526 that is coupled to the system bus 518, but may be connected by other interfaces, such as a parallel port, game port, or a universal serial bus (USB). A media tuner module 560 may also be connected to the system bus 518 to tune audio and video programming (e.g., TV programming) for output through the video adapter 546 or other presentation output modules.

The computer 500 may operate in a networked environment using logical connections to one or more remote computers, such as remote computer 554. These logical connections may be achieved by a communication device coupled to or integral with the computer 500; the invention is not limited to a particular type of communications device. The remote computer 554 may be another computer, a server, a router, a network personal computer, a client, a peer device, or other common network node, and typically includes many or all of the elements described above relative to the computer 500, although only a memory storage device 556 has been illustrated in FIG. 5. The logical connections depicted in FIG. 5 include a local-area network (LAN) 550 and a wide-area network (WAN) 552. Such networking environments are commonplace in office networks, enterprise-wide computer networks, intranets and the Internet, which are all types of networks.

When used in a LAN 550 environment, the computer 500 may be connected to the local network 550 through a network interface or adapter 528, e.g., Ethernet or other communications interfaces. When used in a WAN 552 environment, the computer 500 typically includes a modem 548, a network adapter, or any other type of communications device for establishing communications over the wide area network 552. The modem 548, which may be internal or external, is connected to the system bus 518 via the serial port interface 526. In a networked environment, program modules depicted relative to the personal computer 500, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A system for providing ancillary content in conjunction with playback of primary media content comprising
a media identification module that recognizes an identifier of the primary media content;
a storage repository that stores bonus content delivered out-of-band from the primary media content;
a declarative link list, delivered out-of-band from the primary media content, that associates particular bonus content with the primary media content as the ancillary content;
a look-up module that uses the identifier to discover a storage location of the ancillary content from the declarative link list and accesses the ancillary content from the storage repository; and
a playback module that generates a user interface that presents the ancillary content accessed by the look-up module in conjunction with the primary media content.

2. The system of claim 1 further comprising
a query module that uses the identifier to dynamically search for additional ancillary content at remote locations via a network and receives a non-declarative link identifying a remote location of the additional ancillary content.

3. The system of claim 2, wherein
the look-up module uses the non-declarative link to retrieve the additional ancillary content discovered at one or more of the remote locations by the query module; and wherein
the playback module is further adapted to present the additional ancillary content in conjunction with the primary media content.

4. The system of claim 1, further comprising
a compilation module that receives declarative link information related to ancillary content from the contextual look-up module and creates a notification list identifing the ancillary content available within the bonus content; and wherein
the playback module further presents the notification list in conjunction with the primary media content.

5. The system of claim 3, further comprising
a compilation module that receives declarative link information related to ancillary content and non-declarative link information from the query module and creates a notification list combining the declarative link information and non-declarative link information identifying the ancillary content available; and wherein
the playback module further presents the notification list in conjunction with the primary media content.

6. The system of claim 4, wherein the look-up module is adapted to access the ancillary content in response to user input selecting desired ancillary content from the notification list.

7. The system of claim 5, wherein the look-up module is adapted to access the ancillary content in response to user input selecting desired ancillary content from the notification list.

8. The system of claim 1, further comprising a reception module that receives the bonus content and the declarative link list as a package via a network connected with the system.

9. The system of claim 1, wherein the look-up module is adapted to consider user profile information to discover and access the ancillary content from the storage repository.

10. A system for linking ancillary content to playback of primary media content comprising
an association module that associates identifiers of the primary media content with declarative links to bonus content as related declarative links;
a catalog that stores the related declarative links;
a packaging module that combines the bonus content and the related declarative links as a package of ancillary content; and
a delivery module that transmits the package to a consumer system out-of-band from a delivery of the primary media content.

11. The system of claim 10 further comprising
an aggregation module that combines a plurality of the related declarative links into a single declarative link file that is combined in the package.

12. The system of claim 10 further comprising a receiving module for receiving the bonus content within the system.

13. The system of claim 10 further comprising
an authoring tool that allows a user to author the declarative links by combining location information and notification information regarding a particular piece of bonus material as a particular declarative link.

14. A method for providing ancillary content in conjunction with playback of primary media content, the method comprising
recognizing an identifier of the primary media content;
receiving bonus content out-of-band from the primary media content;
receiving, out-of-band from the primary media content, a corresponding declarative link list that associates particular bonus content with the primary media content to be the ancillary content;
storing the bonus content in a repository;
storing the declarative link list in the repository;
discovering a storage location of the ancillary content from the declarative link list by using the identifier;
accessing the ancillary content from the storage repository; and
generating a user interface for presenting the accessed ancillary content in conjunction with the primary media content.

15. The method of claim 14 further comprising
searching remote locations via a network by using the identifier to find additional ancillary content; and
receiving a non-declarative link identifying a remote location of the additional ancillary content;
retrieving the additional ancillary content by using the non-declarative link to access the remote location; and
presenting the additional ancillary content in conjunction with the primary media content.

16. The method of claim 15 further comprising
creating a notification list combining information from the declarative link list and the non-declarative link identifying the ancillary content available; and
presenting the notification list in conjunction with the primary media content.

17. The method of claim 16, wherein the accessing operation further comprises
selecting particular ancillary content based upon user input in response to the notification list.

18. The method of claim 14 further comprising
receiving a collection of bonus contest and the declarative link list as a package.

19. The method of claim 14, wherein the discovering operation further comprises
considering user profile information to select particular ancillary content from the storage repository.

20. A computor-readable medium having computer-executable instructions for performing a computor process implementing the method of claim 14.
